(19) United States
(12) Patent Application Publication
(10) Pub. No.: US 2012/0022939 A1
(43) Pub. Date: Jan. 26, 2012

(54) Assessing a Response Model Using Performance Metrics

(75) Inventors: Kunal Tiwari, Gurgaon (IN); Harminder Channa, Gurgaon (IN)

(73) Assignee: Bank of America Corporation, Charlotte, NC (US)

(21) Appl. No.: 12/841,652

(22) Filed: Jul. 22, 2010

(51) Int. Cl. G06Q 30/00

(52) U.S. Cl. 705/14.43

(57) ABSTRACT

A computer system determines a response model for a solicited offering based on selected variables that characterize a target population. The response model may be used to identify recipients in the target population to increase the expected probability of the recipients responding. The response model may be formed through an iterative process and is initially formed using a subset of variables from characteristics of the target population. A performance process is then performed to assess the initial response model by rendering, a pool of information for analysis. Based on the results of the analysis, the response model may be modified so that the performance results can be enhanced and updated performance metrics can be further analyzed. When desired results are obtained, the response model is finalized and final performance results are rendered. The response model may then be applied to the target population to identify recipients for the solicited offering.

### FIELD

Aspects of the embodiments relate to a computer system that provides a response model to identify recipients from a target population for a solicited offering.

### BACKGROUND

Businesses often depend on direct advertising to potential customers to market different products. Different modes of communications with potential customers have been implemented since then. For example, the communications world has changed radically since colonial times, especially since 1971, when the Post Office Department of the United States became the United States Postal Service. However, widely held predictions of the demise of the printed word and of direct mail as an effective promotional medium have not turned out to be accurate. However, while printed mailings via traditional “snail mail” may play an important role in direct mailings, electronic advertisements via the Internet may also play a complemental role to traditional mailings.

Direct mailings may be cost-effective, costing between 75 cents and $1 per mailing, including paper, ink, envelopes and postage. It may be effective, averaging between 1 and 3% response rate. It also may allow controlled growth enabling a business to choose how many mailings to send. If a business knows the average response rate, the business knows how many recipients will probably reply.

However, direct mailing advertising campaigns may be viewed as failure by a business when the response rate is significantly less than expected. Businesses may utilize different techniques to motivate the recipient to open the mailing. Direct marketing, specifically direct mail campaigns, is an important ingredient in an effective marketing mix. The reason has to do with the many benefits afforded by this tried-and-true medium, especially because direct mail is targeted and thus allows the advertiser to focus on a very specific audience. Improving the effectiveness of direct marketing often results in improved sales for a business while constraining the associated costs.

### BRIEF SUMMARY

Aspects of the embodiments address one or more of the issues mentioned above by disclosing methods, computer readable media, and apparatuses that determine a response model for a solicited offer (e.g., a direct advertisement mailing) that is developed based on selected variables that characterize a target population of recipients. According to traditional systems, a solicited offer is often mailed to members of the target population without choosing members based on the likelihood that the members will respond to the offer. For example, the offer may be mailed to all members of the target population or a subset may be chosen by randomly selecting members in the target population. Aspects of the invention enable a business to select members of the target population in order to increase the response rate and to predict the response rate to the solicited offer.

The response model may be used to identify recipients in the target population in order to increase the expected probability of the recipients responding to the soliciting offering mailed. The response model may be formed through an iterative process. For example, a business may desire to market a product, which may be tangible (e.g., an automobile) or intangible (e.g., a financial product), in a particular geographical area having many thousands of people. According to traditional systems, if the business were to send mailings to every household, the advertisement may be very expensive and not cost-effective. On the other hand, the business may randomly select households from the particular geographical area. Rather, according to an aspect of the invention, people are selected from the geographical area based on selected variables corresponding to characteristics of the target population.

According to an aspect of the invention, the response model is initially formed using a subset of variables from characteristics of potential customers. A performance process is then performed to assess the initial response model, in which performance metrics are rendered for analysis. Based on the results of the analysis, the response model may be modified so that the performance results can be enhanced and updated performance metrics can be analyzed. When desired results are obtained, the response model is finalized and final performance results are rendered. The response model may then be applied to a target population to identify recipients for the solicited offering.

According to another aspect of the invention, marketing campaigns are supported by developing response models. The response model may be used to target potential customers who are most likely to respond to the solicited offering. Development of a response model by a computer system may require many logistic iterations, and model performance metrics for the response model may be checked for each iteration. According to traditional systems, each iteration may include a manual procedure for finalizing model estimates, where the corresponding manual activities often account for significant model development time. With another aspect of the invention, the manual procedure may be replaced with a SAS® Software macro for generating model performance metrics with no manual touch points consequently reducing model development time. The macro typically significantly reduces the number of steps for performance metrics report generation. Using of the macro may significantly reduce development costs of the response model.

With another aspect of the invention, an initial response model is generated with a subset of variables from a set of variables that characterize a target population. A pool of information about the response model is then determined and at least one model attribute is extracted. The at least one model attribute is then compared with a predetermined desired level. When the at least one model attribute is not acceptable, the response model is modified and the updated response model is re-assessed. When the at least one model attribute is acceptable, an output is rendered so that the response model can be applied to the target population.

With another aspect of the invention, a variable may be added to the subset of variables in order to enhance the predicted response rate. Variables of the subset may be transformed in order to increase the predicative capabilities of the response model. Also, a variable may be deleted from the subset if the statistical significance is not sufficient.

With another aspect of the invention, a response model may be applied at a subsequent time after obtaining the model. If a model attribute significantly changes, the response model may be updated to better reflect the dynamic characteristics of the target population.

Aspects of the embodiments may be provided in a computer-readable medium having computer-executable instructions to perform one or more of the process steps described herein.

These and other aspects of the embodiments are discussed in greater detail throughout this disclosure, including the accompanying drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative operating environment in which various aspects of the invention may be implemented.

FIG. 2 is an illustrative block diagram of workstations and servers that may be used to implement the processes and functions of certain aspects of the present invention.

FIG. 3 shows a block diagram of a system in accordance with an aspect of the invention.

FIG. 4 shows a flow chart for a process that determines performance metrics for a response model in accordance with an aspect of the invention.

FIG. 5 shows an exemplary computer program listing of a decile performance process in accordance with an aspect of the invention.

FIG. 6 shows a continuation of the exemplary computer program listing in FIG. 5.

FIG. 7 shows a continuation of the exemplary computer program listing in FIGS. 5 and 6.

FIG. 8 shows a flow chart for the illustrative computer program listing that is shown in FIGS. 5-7.

FIG. 9 shows exemplary output results for a process that determines performance metrics of a response model in accordance with an aspect of the invention.

FIG. 10 shows a flow chart for a process that updates a response model for each iteration of the process in accordance with an aspect of the invention.

FIG. 11 shows a flow chart for a process that assesses a response model at a time subsequent to the completion of the model in accordance with an aspect of the invention.

FIG. 12 shows a set of variables included in a response model in accordance with an aspect of the invention.

FIG. 13 shows performance indicators for the variable set shown in FIG. 12 in accordance with an aspect of the invention.

FIG. 14 shows a set of variables included in a response model in accordance with an aspect of the invention.

FIG. 15 shows performance indicators for the variable set shown in FIG. 14 in accordance with an aspect of the invention.

### DETAILED DESCRIPTION

In accordance with various aspects of the invention, methods, computer-readable media, and apparatuses are disclosed in which a response model for a solicited offering (e.g., a direct advertisement mailing) is developed based on selected variables that characterize a target population of recipients. The response model may be used to identify recipients in the target population in order to increase the expected probability of the recipients responding to the solicited offering. The response model may be formed through an iterative process, in which at least a portion of the process is performed on a computer system.

For example, a business may desire to market a product, which may be tangible (e.g., an automobile) or intangible (e.g., a financial product), in a particular geographical area having many thousands of people. According to traditional systems, if the business were to send mailings to every household, the advertisement may be very expensive and not cost-effective. On the other hand, the business may randomly select households from the particular geographical area. Rather, according to an aspect of the invention, people are selected from the geographical area based on selected variables corresponding to characteristics of the target population.

According to an aspect of the invention, the response model is initially formed using a subset of variables from characteristics of the target population. A performance process is then performed to assess the initial response model, in which performance metrics are rendered for analysis. Based on the results of the analysis, the response model may be modified so that the performance results may be enhanced and updated performance metrics may be analyzed. When desired results are obtained, the response model is finalized and final performance results are rendered. The response model may then be applied to a population of potential customers to identify recipients for the solicited offering.

According to one aspect of the invention, marketing campaigns are supported by developing response models. The response model may be used to target potential customers who are most likely to respond to the solicited offering. Development of a response model by a computer system may require many logistic iterations, and model performance metrics for the response model may be checked for each iteration. According to traditional systems, each iteration may include a manual procedure for finalizing model estimates, where the corresponding manual activities often account for significant model development time.

With an aspect of the invention, as will be discussed, the manual procedure is replaced with a SAS® Software macro for generating model performance metrics with no manual touch points reducing model development time. The macro typically significantly reduces the number of steps for performance metrics report generation, and thus using the macro significantly reduces development costs of the response model.

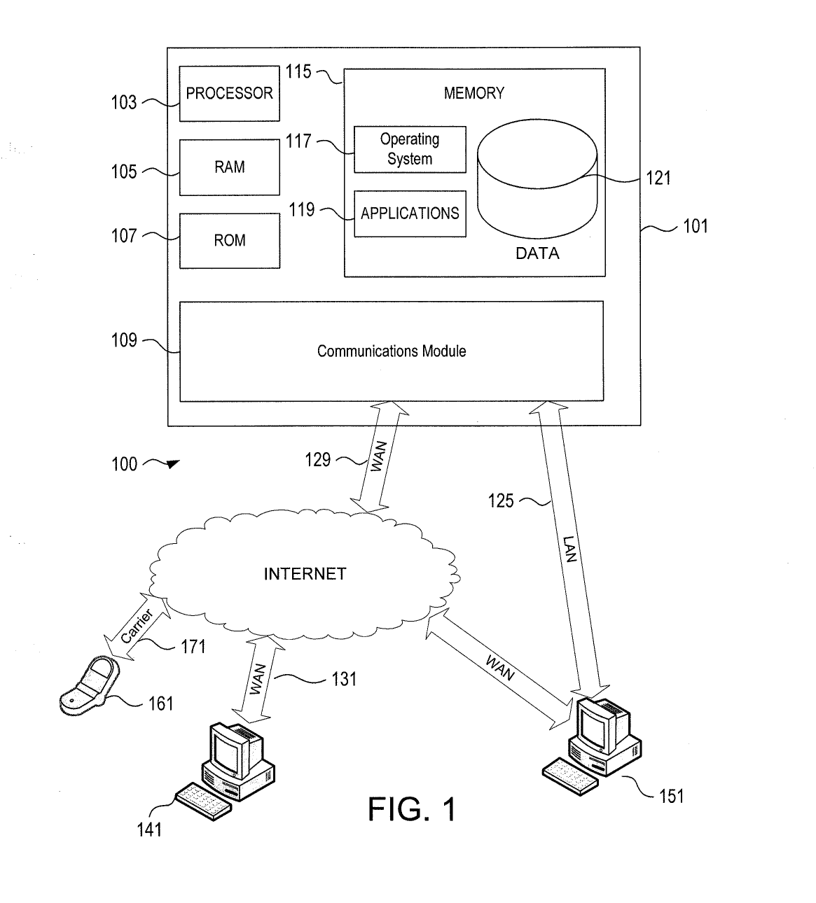

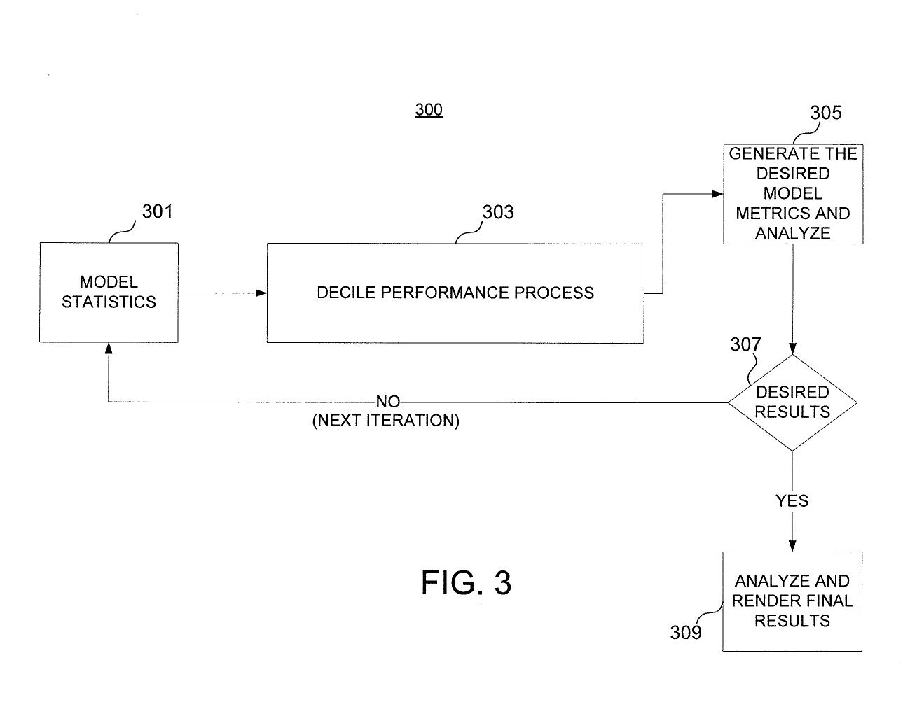

FIG. 1 illustrates an example of a suitable computing system environment 100 (e.g., for process 303 as shown in FIG. 3) that may be used according to one or more illustrative embodiments. Some portion or all of process 300, as shown in FIG. 3, may be performed by system environment 100. For example, as will be further discussed, decile performance process 303 may be implemented as a software macro and executed by processor 103. The computing system environment 100 is only one example of a suitable computing environment and is not intended to suggest any limitation as to the scope of use or functionality of the invention. The computing system environment 100 should not be interpreted as having any dependency or requirement relating to any one or combination of components shown in the illustrative computing system environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including RAM 105, ROM 107, communications module 109, and memory 115. Computing device 101 typically includes a variety of computer readable media. Computer readable media may be any available media that may be accessed by computing device 101 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 100 may also include optical scanners (not shown). Exemplary usages include scanning and converting paper documents, e.g., correspondence, receipts, etc. to digital files.

Although not shown, RAM 105 may include one or more are applications representing the application data stored in RAM memory 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Alternatively, some or all of the computer executable instructions for computing device 101 may be embodied in hardware or firmware (not shown). Database 121 may provide centralized storage of information about the target population as well as information about the response model that may be received from different points in system 100, e.g., computers 141 and 151 or from communication devices, e.g., communication device 161.

Computing device 101 may operate in a networked environment supporting connections to one or more remote computing devices, such as branch terminals 141 and 151. The branch computing devices 141 and 151 may be personal computing devices or servers that include many or all of the elements described above relative to the computing device 101. Branch computing device 161 may be a mobile device communicating over wireless carrier channel 171.

The network connections depicted in FIG. 1 include a local area network (LAN) 125 and a wide area network (WAN) 129, but may also include other networks. When used in a LAN networking environment, computing device 101 is connected to the LAN 825 through a network interface or adapter in the communications module 109. When used in a WAN networking environment, the server 101 may include a modem in the communications module 109 or other means for establishing communications over the WAN 129, such as the Internet 131. It will be appreciated that the network connections shown are illustrative and other means of establishing a communications link between the computing devices may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages. The network connections may also provide connectivity to a CCTV or image/iris capturing device.

Additionally, one or more application programs 119 used by the computing device 101, according to an illustrative embodiment, may include computer executable instructions for invoking user functionality related to communication including, for example, email, short message service (SMS), and voice input and speech recognition applications.

Embodiments of the invention may include forms of computer-readable media.

Computer-readable media include any available media that can be accessed by a computing device 101. Computer-readable media may comprise storage media and communication media. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the invention is contemplated. For example, aspects of the method steps disclosed herein may be executed on a processor on a computing device 101. Such a processor may execute computer-executable instructions stored on a computer-readable medium.

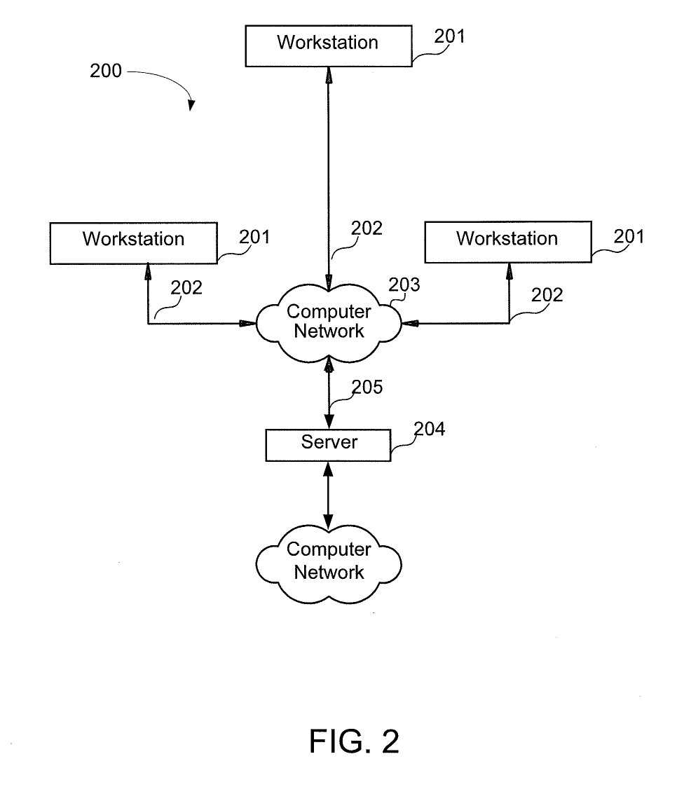

Referring to FIG. 2, an illustrative system 200 for implementing methods according to the present invention is shown. As illustrated, system 200 may include one or more workstations 201. Workstations 201 may be local or remote, and are connected by one of communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc. Connectivity may also be supported to a CCTV or image/iris capturing device.

The steps that follow in the Figures may be implemented by one or more of the components in FIGS. 1 and 2 and/or other components, including other computing devices.

FIG. 3 shows block diagram of a process 300 in accordance with an aspect of the invention. Marketing campaigns may be supported by developing response models. The response model may be used to target customers who are most likely to respond to a solicited offering. Development of a response model by a computer system may require many logistic iterations (e.g., forty or fifty), and model performance metrics for the response model may be checked for each iteration. According to traditional systems, each iteration may include a manual procedure for finalizing model estimates, where the corresponding manual activities often account for significant model development time.

At block 301 a response model is initially formed using a subset of variables from characteristics of potential customers. The subset of variables (x₁, x₂, . . . , xₘ) may be used to determine at least one model attribute such as a performance metric (PERF_METRIC). The performance may be indicative of the probability that a recipient of a solicited offering (e.g., an advertisement for a service or a manufactured item) will respond to the solicited offering. Variables typically represent characteristics of members within a target population. For example, a target population may be residents of a geographic region (e.g., as a city). Exemplary variables include the credit score, age, and income of an individual. The possible set of variables may be large with hundreds of variables. However, a response model may use a small subset of the variables, for example, from five to ten variables.

PERF_METRIC may be modeled as a function that depends on the subset of variables:

PERF_METRIC=F(T₁(x₁),T₂(x₂), . . . ,Tₘ(xₘ)) (EQ. 1)

where Tᵢ, is the corresponding transformation of the i^{th} variable. Embodiments support different types of transformations, including linear, exponential, logarithmic, and the like.

With some embodiments, decile performance process 303 provides a pool of information that assists in the determination of performance model. For example, the pool of information may include macro output 900. While process 303 may partition a target population into deciles, other embodiments may partition the target population into different partitions with uniform and non-uniform partitioning.

With some embodiments, process 300 provides a Kolmogorov-Smirnov (K-S) value that is indicative of the significance of a set of variables for the model overall. For example, a user of process 300 may select a set of variables that is significant as well as assists in better targeting a cumulative responder capture percentage. Process 300 may provide performance indications of different sets of significant variables that may be less significant but under a permissible limit. Consequently, the user may have an option to select a model based on a targeting criterion.

With some embodiments, process 303, which is often a manual procedure with traditional systems, is implemented as a SAS® Software macro for generating model performance metrics with no manual touch points reducing model development time. The macro may significantly reduce the number of steps for performance metrics report generation, and thus using the macro significantly reduces development costs of the response model.

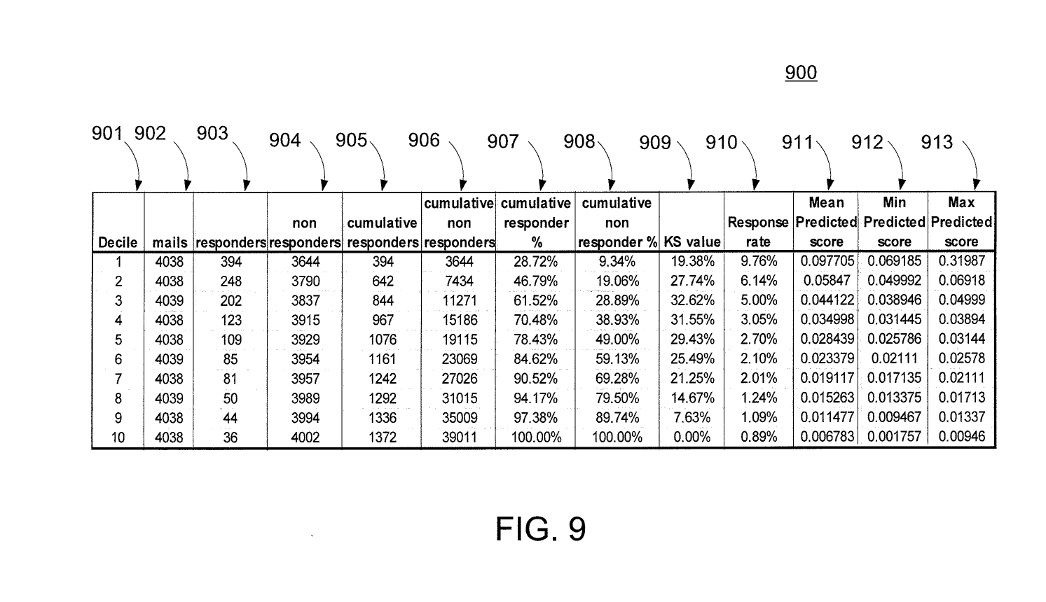

Performance process 303 is then performed to assess the response model, in which performance metrics (e.g., predicted scores 911-913 as shown in FIG. 9) are rendered for analysis. Based on the results of the analysis by blocks 305 and 307, the response model may be modified so that the performance results may be enhanced and updated performance metrics may be further analyzed. When desired results are obtained by block 307, the response model is finalized and final performance results are rendered. The response model may then be applied to the target population to identify recipients for a solicited offering (e.g., a direct mailing advertisement).

According to some embodiments, block 307 compares predicted response rate 910 (as shown in FIG. 9) with a desirable (acceptable) response rate. For example, a business may determine that the minimum response rate to a mailed advertisement is 3% in order for the costs for preparing and mailing the advertisement to be cost effective. However, other embodiments may use a different approach. For example, some embodiments may continue repeating process 300 until the largest predicted performance metric is obtained by the response model or until the performance metric sufficiently converges to a performance limit.

After desired performance results have been obtained, block 309 analyzes and renders final results so that a solicited offer can be executed. In addition to including output 900, the final results may include a listing of recipients of the target population. The final results also may include the performance metric function based on EQ. 1 of the response model (i.e., EQ. 1) so that the response model may be applied to a different target population that has similar characteristics as what was modeled by process 300.

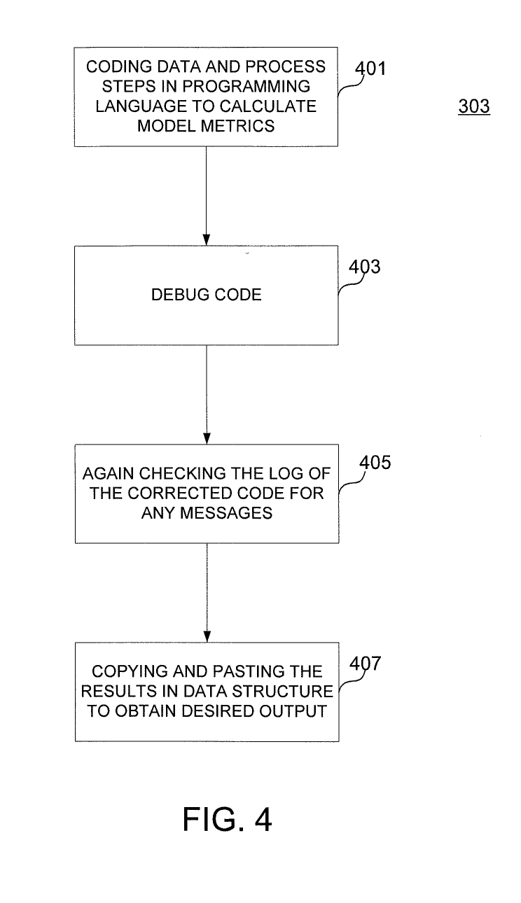

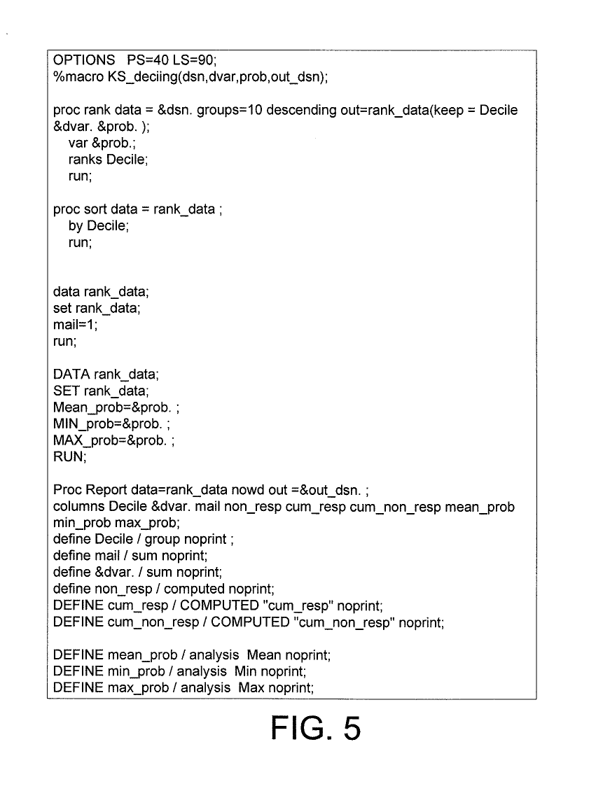

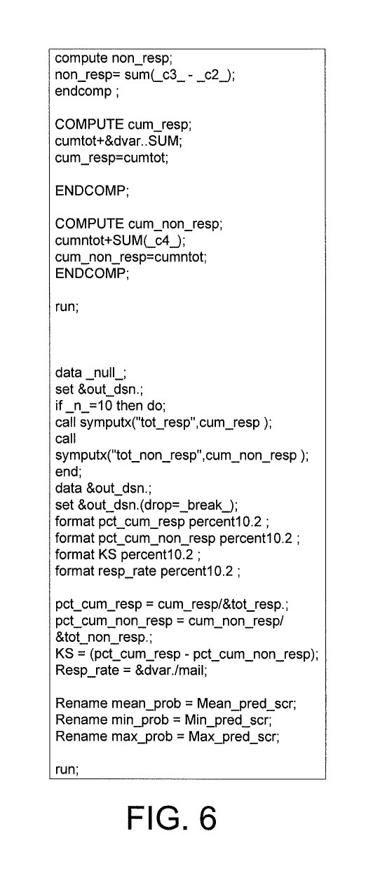

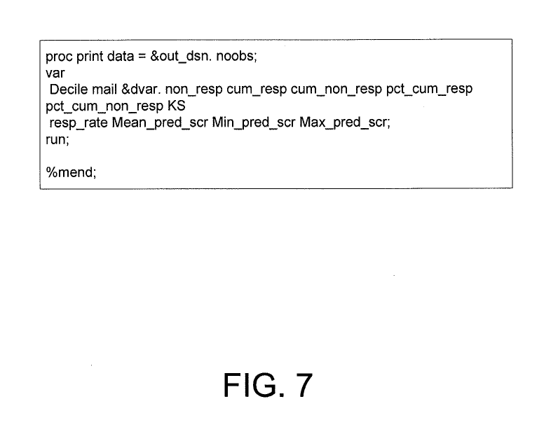

FIG. 4 shows a flow chart for process 303 that determines performance metrics for a response model in accordance with an aspect of the invention. As illustrated in FIGS. 5-7, software code to produce computer-executable instructions is generated to calculate performance metrics at block 401. At block 403, the software code is verified whether it is consistent with the rules of the associated computer language. If any errors in the software code are detected, the software code is corrected and verified for any additional errors at block 405. The computer-executable instructions produced by the software code at block 405 are then executed to provide an output that is indicative of the performance results. The output is transferred to a designated memory structure, e.g., a spreadsheet, at block 407.

Process 300 may produce required numbers that help a user to decide a response model.

With some embodiments, the process may be implemented as a macro, which is a rule or pattern that specifies how a certain input sequence of characters should be mapped to an output sequence according to a defined procedure. The following listing initiates a macro expansion that is implemented with SAS® Software.

*rsubmit;
%include ‘/mkt/consumer/campaign/isg/nbkgzys/Macro_ks_decile.sas’
/source2 source;
/*This is where the macro is permanently stored*/
%KS_deciing(dsn,dvar,prob,out_dsn);
/*

The above macro call includes macro arguments Dsn, Dvar, Prob, and Out_dsn. With some embodiments:

dsn: This is the name of the input dataset on which we are applying the macro. This can be output data generated after running proc logistic or any dataset with information about the dependent variable and probability scores.
dvar: It is the name of the dependent binary variable.
prob: It is the name of the probability scores. These can be from the logistic output or using a model scoring code.
out_dsn: It is the name of the output dataset name.

Each macro call results in a macro expansion that instantiates (transforms) the macro into a specific output sequence as shown in FIGS. 5-7.

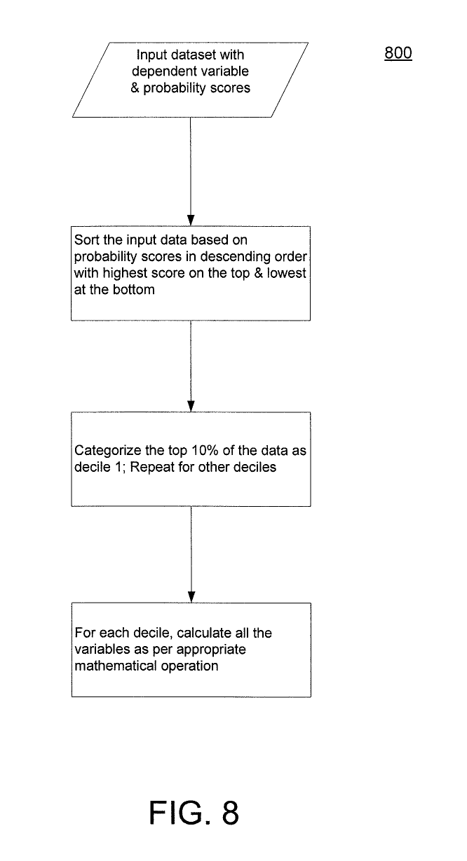

FIGS. 5-7 show an illustrative computer program listing of a decile performance process in accordance with an aspect of the invention. FIG. 8 shows a flow chart for the illustrative computer program listing shown in FIGS. 5-7.

FIG. 9 shows output results 900 for process 303 that determines performance metrics of a response model in accordance with an aspect of the invention. With the exemplary output results shown in FIG. 9:

Decile 901: It divides the sorted data (on the basis of predicted score variable) into 10 equal parts i.e. each decile contains 10% of the population.
Mails 902: It refers to the total number of mails captured by deciles.
Responders 903: It refers to the total number of responders captured by deciles.
Non-Responders 904: It refers to the total number of non-responders captured by deciles.
Cumulative responders 905: It is the cumulative number of responders by deciles. For example, for decile 3, the value is 844, which is the sum of responders column 903 for the 3 deciles.
Cumulative Non-responders 906: It is the cumulative number of non-responders by deciles. For example, for decile 3, the value is 11271, which is the sum of non responders column 904 for the 3 deciles.
Cumulative responder % 907: It is the percentage of the responders from the Cumulative responders column 905 captured in a decile by the total number of responders. For example, for decile 5, this value is 1076 divided by 1372.
Cumulative non responder % 908: It is the percentage of the non-responders from the Cumulative non responders column 906 captured in a decile by the total number of non-responders. For example, for decile 5, this value is 19115 divided by 39011.
K-S Value 909: It is a measure that tells how good the model is in separating responders from non-responders. It is the difference between cumulative responders % column 907 and cumulative non-responders % column 908. For example, for decile 5, this value is 78.43% minus 49.00%.
Response rate 910: It is the percentage of the responders from the responders column 903 captured by the total number of mails column 902. For example, for decile 1, this value is 394 divided by 4038.
Mean Predicted Score 911: It is the average of the predicted score variable for all the mails. The calculation is done in the background. For example, for decile 5, this number is the average of the predicted score variable for all the 4038 mails which comes out to be 0.028439.
Min Predicted Score 912: It is the minimum score of all the mails in a decile. For example, in decile 1, the minimum score is 0.0977005 out of 4038 mails in that decile.
Max Predicted Score 913: It is the maximum score of all the mails in a decile. For example, in decile 1, the minimum score is 0.31987 out of 4038 mails in that decile.

Process 303 partitions the target population into ten equal parts (corresponding to deciles 801). Process 303 then determines response rate 910 (i.e., responders 903 divided by the number of mails 902). Deciles 901 are ranked ordered so that the first decile has the highest response rate, followed by the second decile, and so forth. Consequently, solicited offerings are typically mailed to recipients in the first decile.

Output 900 also may include performance metrics for each decile. For example, K-S value 909 is indicative that a predicted responder is really a responder and that a predicted non-responder is really a non-responder. With some embodiments, the Kolmogorov-Smirnov test (K-S test) is used to determine a minimum distance estimation based on a non-parametric test of equality of multi-dimensional probability distributions.

In addition, output 900 includes performance metrics that are indicative of the average, minimum, and maximum predicted scores 911-913 for each decile 901. Minimum predicted score 912 and maximum predicted score 913 are indicative of the variation of the actual response due to the stochastic nature of the target population.

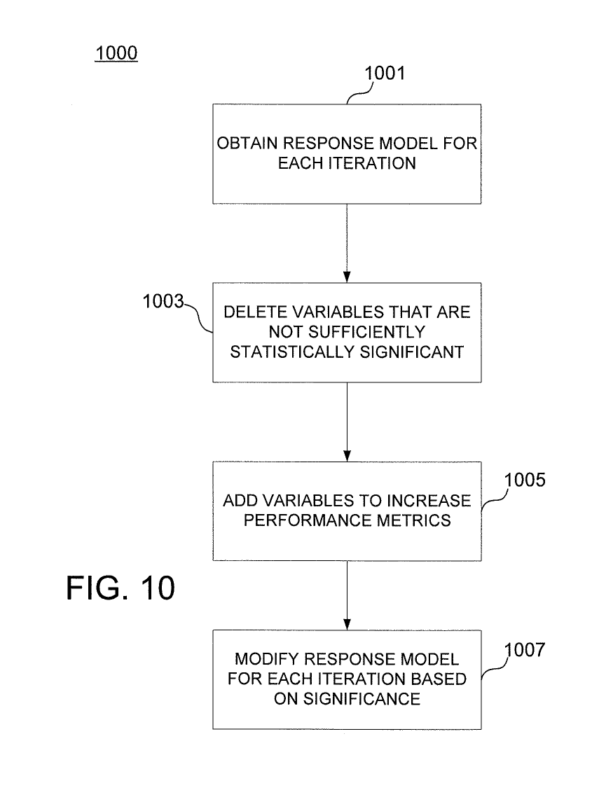

FIG. 10 shows a flow chart for process 1000 that updates the response model for each iteration of process 300 in accordance with an aspect of the invention. At block 1001, the response model is obtained for the current iteration. As previously discussed, the response model includes a subset of variables from a set of variables that characterize the target population as well as any transformations of those variables.

At block 1003, a variable may be deleted from the response model if the variable is sufficiently statistically insignificant to the determination of the probability that a recipient in the target population will respond. Statistically insignificant variables typically do not enhance the performance metrics. With some embodiments, the degree of significance may be based on the p-value of the variable. Statistically insignificant variables are not typically included in the model. Variables may be added so that the model includes all of the significant variables with a high targeting rate. The response model may include less significant variables under a permissible significance limit but with high responder capture % and high K-S value.

With some embodiments, different subsets of variables may be compared with each other in relation to the corresponding performance metrics. If two subsets are characterized by similar performance metrics (e.g., within a predetermined percentage), process 300 may select the subset with the fewer number of variables. This approach may simplify the response model while having the desired predicative capabilities.

Process 300 is typically repeated so that the response model can be modified in order to increase the performance metrics. Typically, variables may be added at block 1005 to the response in order to enhance the performance metrics. The response model is modified at block 1007 so that another iteration may be executed or final results may be rendered by process 300.

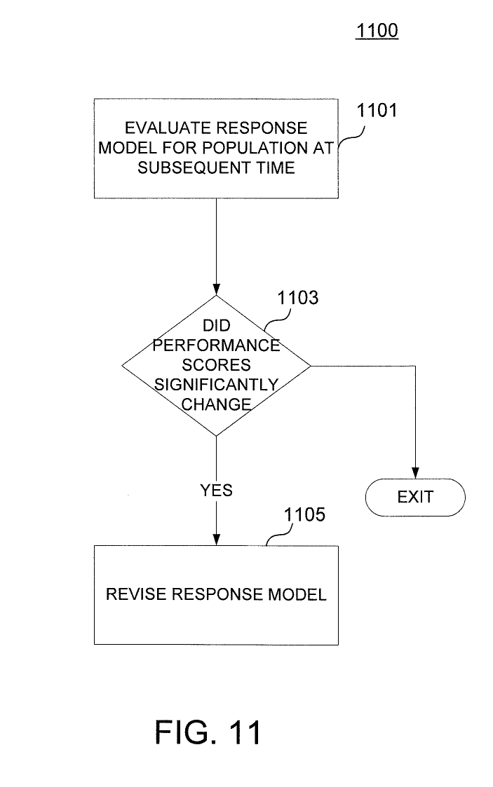

FIG. 11 shows a flow chart for process 1100 that assesses a response model at a time subsequent to the completion of the model in accordance with an aspect of the invention. Because of external conditions, the characteristics of a target population may be dynamic. For example, the banking crisis in the United States during the years of 2008 and 2009 caused a major disruption in many people's financial situation. Consequently, financially related characteristics of individuals changed. Referring to output 900, performance scores 911-913 may change, thus indicating that the underlying response model should be updated to account for the dynamic nature of the target population.

After a response model has been previously obtained, the response model may be used for the target population at a subsequent time at block 1101. If performance scores 911-913 substantially changes (e.g., as determined at block 1103 by comparing to predetermined thresholds or detecting a relative percentage change), the response model is revised at block 1105 by re-executing process 300 as previously discussed.

The following example illustrates process 300 that is shown in FIG. 3 when a user is about to finalize the response model. Two model variable sets (set A and set B) are considered.

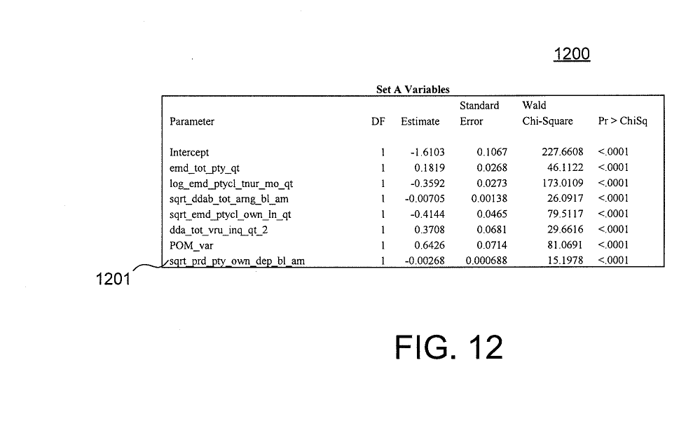

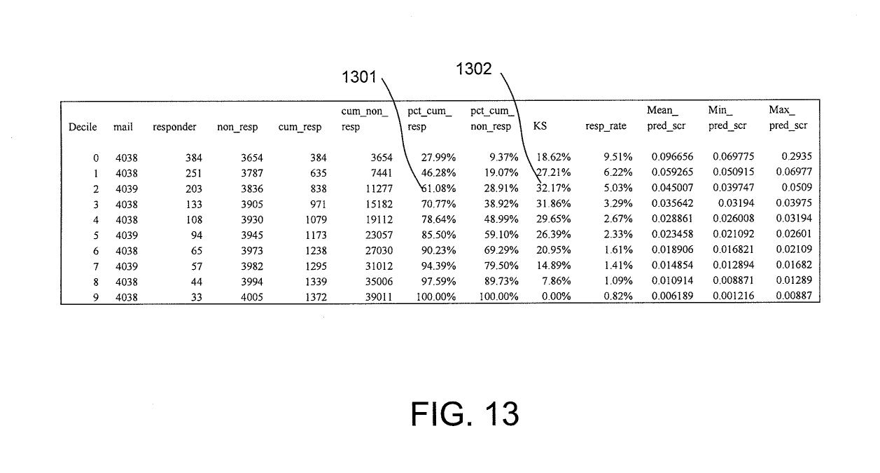

As shown in FIG. 12, variable set 1200 contains seven variables where all are significant with main performance numbers as responder capture %=61.08 and K-S value=32.17 (shown as values 1301 and 1302, respectively, in FIG. 13). A user (modeler) may attempt to further improve the performance with the final model.

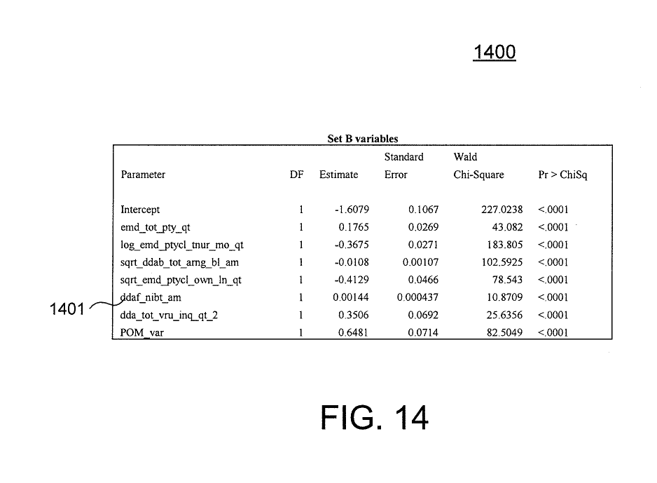

The least significant variable out of set 1200 is sqrt_prd_pty_own_dep_bl_am 1201, which may be replaced with ddaf_nibt_am 1401 to obtain variable set 1400 (as shown in FIG. 14).

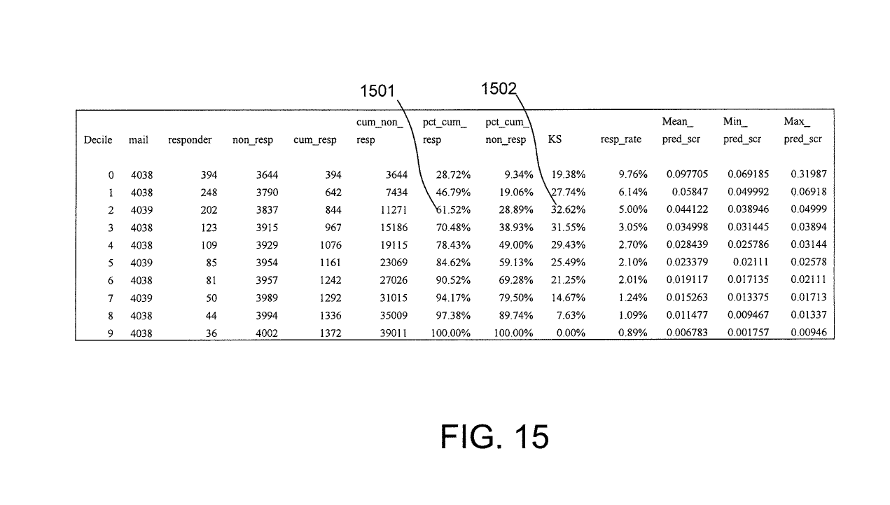

When the user looks at the statistics, the user may determine that variable ddaf_nibt_am 1401 is not as significant as the replaced variable sqrt_prd_pty_own_dep_bl_am 1201, but performance indicators may be better than with set 1200 where responder capture %=61.52 and K-S value=32.62 (shown as values 1501 and 1502, respectively, in FIG. 15).

Aspects of the embodiments have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the embodiments. They may determine that the requirements should be applied to third party service providers (e.g., those that maintain records on behalf of the company).

We claim:

1. A computer-assisted method comprising:
generating a response model with a subset of variables from a set of variables, the set of variables characterizing a target population, wherein said response model is predictive of whether a recipient is likely to respond to a solicited offer;
determining, by a computer system, a pool of information that provides statistical characteristics about the response model;
extracting at least one model attribute from the pool of information;
comparing the at least one model attribute with a predetermined desired level;
when the at least one model attribute does not meet a predefined criterion, modifying the response model and repeating the determining, the extracting, and the comparing; and
when the at least one model attribute meets the predefined criterion, rendering an output based on the response model.

2. The method of claim 1, wherein the at least one model attribute comprises a performance metric.

3. The method of claim 1, wherein the at least one model metric comprises a statistical metric.

4. The method of claim 1, wherein the modifying comprises:
determining a statistical significance of one of the variables in the subset; and
deleting said one variable when the statistical significance is less than a predetermined significance level.

5. The method of claim 4, wherein the modifying further comprises:
adding another variable to the subset from the set of variables.

6. The method of claim 1, wherein the modifying comprises:
transforming one of the variables in the subset based on the pool of information.

7. The method of claim 1, further comprising:
applying the response model to the target population at a subsequent time;
obtaining at least one updated model attribute at the subsequent time;
determining a difference between the at least one updated model attribute and the at least one model attribute that was previously extracted; and
updating the response model when the difference is greater than a predetermined amount.

8. The method of claim 7, wherein the at least one updated model attribute is indicative of a predication score.

9. The method of claim 1, further comprising:
when the at least one model attribute converges within a predetermined range, rendering the output based on the response model.

10. The method of claim 1, further comprising:
partitioning the target population into a plurality of sub-populations; and
generating the output to be indicative of the plurality of sub-populations.

11. The method of claim 1, further comprising:
applying the response model to a different target population.

12. The method of claim 1, further comprising:
comparing a first subset of variables with a second subset of variables; and
selecting one of the subset of variables for the response model based on the comparing.

13. An apparatus comprising:
at least one memory; and
at least one processor coupled to the at least one memory and configured to perform, based on instructions stored in the at least one memory:
generating a response model with a subset of variables from a set of variables, the set of variables characterizing a target population, wherein said response model is predicative of whether a recipient is likely to respond to a solicited offer;
determining a pool of information that provides statistical characteristics about the response model;
extracting at least one performance metric from the pool of information;
comparing the at least one performance metric with a predetermined desired level;
when the at least one performance metric is not desirable, modifying the response model and repeating the determining, the extracting, and the comparing; and
when the at least performance metric is desirable, rendering an output based on the response model.

14. The apparatus of claim 13, wherein the at least one processor is further configured to perform:
determining a statistical significance of one of the variables in the subset; and
deleting said one variable when the statistical significance is less than a predetermined significance level.

15. The apparatus of claim 14, wherein the at least one processor is further configured to perform:
adding another variable to the subset from the set of variables.

16. The apparatus of claim 13, wherein the at least one processor is further configured to perform:
transforming one of the variables in the subset based on the pool of information.

17. The apparatus of claim 13, wherein the at least one processor is further configured to perform:
applying the response model to the target population at a subsequent time;
obtaining at least one updated performance metric at the subsequent time;
determining a difference between the at least one updated performance metric and the at least one performance metric that was previously extracted; and
updating the response model when the difference is greater than a predetermined amount.

18. The apparatus of claim 13, wherein the at least one processor is further configured to perform:
comparing a first subset of variables with a second subset of variables; and
selecting one of the subset of variables for the response model based on the comparing.

19. A computer-readable storage medium storing computer-executable instructions that, when executed, cause a processor to perform a method comprising:
generating a response model with a subset of variables from a set of variables, the set of variables characterizing a target population, wherein said response model is predicative of whether a recipient is likely to respond to a solicited offer;
determining a pool of information that provides statistical characteristics about the response model;
extracting at least one model attribute from the pool of information;
comparing the at least one model attribute with a predetermined desired level;
when the at least one model attribute is not desirable, modifying the response model and repeating the determining, the extracting, and the comparing;
when the at least model attribute is desirable, rendering an output based on the response model; and
applying the response to the target population to identify a set of recipients for the solicited offer.

20. The computer-readable medium of claim 19, said method further comprising:
determining a statistical significance of one of the variables in the subset; and
deleting said one variable when the statistical significance is less than a predetermined significance level.

21. The computer-readable medium of claim 19, said method further comprising:
adding another variable to the subset from the set of variables.

22. The computer-readable medium of claim 19, said method further comprising:
applying the response model to the target population at a subsequent time;
obtaining at least one updated model attribute at the subsequent time;
determining a difference between the at least one updated model attribute and the at least one model attribute that was previously extracted; and
updating the response model when the difference is greater than a predetermined amount.
